(19) United States
(12) Patent Application Publication
(10) Pub. No.: US 2008/0074173 A1
(43) Pub. Date: Mar. 27, 2008

(54) Current source circuit having a dual loop that is insensitive to supply voltage

(75) Inventor: Yu-Jen Tu, Hsinchu (TW)

Correspondence Address: BIRCH STEWART KOLASCH & BIRCH, PO BOX 747, FALLS CHURCH, VA, 22040-0747, US

(73) Assignee: AVID ELECTRONICS CORP.

(21) Appl. No.: 11/526,018

(22) Filed: Sep. 25, 2006

(51) Int. Cl. G05F 1/10

(52) U.S. Cl. 327/543

(57) ABSTRACT

A current source circuit having dual feedback paths that is insensitive to supply voltage includes a first current mirror having a first PMOS transistor and a second PMOS transistor. A second current mirror cascodes with the first current mirror including a first NMOS transistor and a second NMOS transistor. The first current mirror and the second current mirror are respectively coupled to a third PMOS transistor and a third NMOS transistor. The third PMOS transistor, the third NMOS transistor and the second PMOS transistor and the second NMOS transistor form a positive feedback path. The third PMOS transistor, the third NMOS transistor and the first PMOS transistor and the first NMOS transistor form a negative feedback path. A gain of the negative feedback path is larger than the gain of the positive feedback path. In this way, an overall gain of the current source is effectively enhanced.

### BACKGROUND OF THE INVENTION

1. Field of the Invention

The invention relates in general to a current source circuit, and more particularly to a current source circuit having dual feedback paths that is insensitive to supply voltage.

2. Description of the Related Art

With reference to FIG. 7, an essential circuit structure of a conventional constant-gm bias current source includes a first PMOS transistor MP1 a second PMOS transistor MP2 coupled together by a gate, a first NMOS transistor MN1 and a second NMOS transistor MN2 coupled together by a gate. A connection node of the first PMOS transistor MP1 and the second PMOS transistor MP2 is further coupled to a drain of the second PMOS transistor MP2 to form a current mirror. A connection node of the first NMOS transistor MN1 and the second NMOS transistor NMOS is further coupled to a drain of the first NMOS transistor MN2 to form another current mirror. The aforesaid two current mirrors form a current source circuit of cascode current mirrors.

The aforesaid current source circuit is widely used. General technique reports indicate that the aforesaid MOS transistors of the MP1, MP2, MN1 and MN2 make up the current source circuit of the cascode current mirrors scheme which is so called supply independent current mirror. Hence the current and voltage of the circuit are relatively stable and do not have a dramatic change when power supply changes. However, in fact this is not true in some specific situations, since an output resistance value Ro of the MOS transistors is not infinite, which means a loop gain can not be infinite. In such a situation, when the supply voltage changes dramatically, an output current value of the current source circuit will also have a big change. A current-to-voltage feature curve of the current source circuit is shown in FIG. 8. Two curves in the diagram respectively represent the current values of the first and the second PMOS transistors MP1 and MP2 of the cascode current mirrors under different supply voltage. The curves clearly show that when the supply voltage ascends from 1.5 volts to 5.5 volts, the current values of the PMOS transistors MP1 and MP2 appear a current variation for more than two times. However, the current variation is not allowed for many electronic devices, which require a stable current value.

In order to solve the aforesaid current variation problem, a conventional cascode current source was provided as shown in FIG. 9. The transistors MP1, MP2, MN1 and MN2 of the current source circuit are cascoded to MOS transistors MP3, MP4, MN3 and MN4 of the same channel. In this way, the output resistance value Ro of the MOS transistors can be enhanced, which implies that the current variation along with the change of supply voltage can be effectively controlled. However, even though the aforesaid method solves the current variation problem, another problem comes out. The additional MOS transistors are cascoded, so as to cause an obvious voltage drop. Hence when the supply voltage is low, the current source circuit can not work, which is another disadvantage in applications.

### SUMMARY OF THE INVENTION

A main objective of the present invention is to provide a current source circuit having dual feedback paths that is insensitive to supply voltage.

In order to achieve the above objective, a current source circuit that is insensitive to supply voltage has

a first current mirror includes a first PMOS transistor and a second PMOS transistor coupled to each other by a gate;

a second current mirror cascodes with the first current mirror including a first NMOS transistor and a second NMOS transistor coupled to each other by a gate. A connection node is further coupled to a drain of the first NMOS transistor. A source of the first transistor NMOS is coupled to a resistor;

a third PMOS transistor includes a gate and a drain both coupled together to a gate node of the first current mirror; and

a third NMOS transistor includes a drain coupled to the drain of the third PMOS transistor and a gate coupled to a drain node of the second PMOS transistor and the second NMOS transistor.

The third PMOS transistor, the third NMOS transistor and the second PMOS transistor and the second NMOS transistor form a positive feedback path. The third PMOS transistor, the third NMOS transistor and the first PMOS transistor and the first NMOS transistor form a negative feedback path. A gain of the negative feedback path is larger than the gain of the positive feedback path. In this way, an overall gain of the current source is effectively enhanced, so as to greatly enhance capability against the changes of the supply voltage, which achieves an objective of becoming insensitive to supply voltage.

The current source circuit that is insensitive to supply voltage further includes a start-up circuit. The start-up circuit includes a detection circuit and a driving circuit.

The detection circuit includes an input terminal coupled to a drain node of the first PMOS transistor and the first NMOS transistor.

The driving circuit includes an input terminal coupled to the detection circuit and multiple output terminals respectively coupled to the drain node of the second PMOS transistor and the second NMOS transistor and the drain node of the third PMOS transistor and the third NMOS transistor.

The detection circuit includes a NMOS transistor and an inverter.

The NMOS transistor of the detection circuit includes a gate coupled to the drain node of the first PMOS transistor and the first NMOS transistor and a drain coupled to power source through a resistor.

The inverter includes an output terminal coupled to the drain of the NMOS transistor. The output terminal of the inverter forms an output terminal of the detection circuit.

The driving circuit includes a switch transistor and a cascode transistor module. The switch transistor includes a gate coupled to the output terminal of the detection circuit and a drain coupled to the drain node of the second PMOS transistor and the second NMOS transistor. The cascode transistor module includes two PMOS transistors and one NMOS transistor of series connection. A gate of one of the PMOS transistors is coupled to the output terminal of the detection circuit and a source of the other PMOS transistor is coupled to the drain of the PMOS transistor. The gate and the drain are coupled to the drain node of the third PMOS transistor and the second NMOS transistor. A drain of the NMOS transistor is coupled to the drain of the PMOS transistor.

### BRIEF DESCRIPTION OF THE DRAWINGS

FIG. 1 is a detailed circuit diagram of a preferred embodiment of a current source circuit in accordance with the present invention;

FIG. 2 is a detailed circuit diagram of the preferred embodiment of the current source circuit that marks positive and negative feedback paths;

FIG. 3 is a characteristic curve graph of current versus voltage having three curves;

FIG. 4 is a characteristic curve graph of current versus voltage that the present invention operates under different temperatures;

FIG. 5 is a detailed circuit diagram of the current source circuit with an initial circuit in accordance with the present invention;

FIG. 6 is a characteristic curve graph of current versus voltage of the current source circuit with the initial circuit in accordance with the present invention;

FIG. 7 is a circuit diagram of a conventional current source circuit in accordance with the prior art;

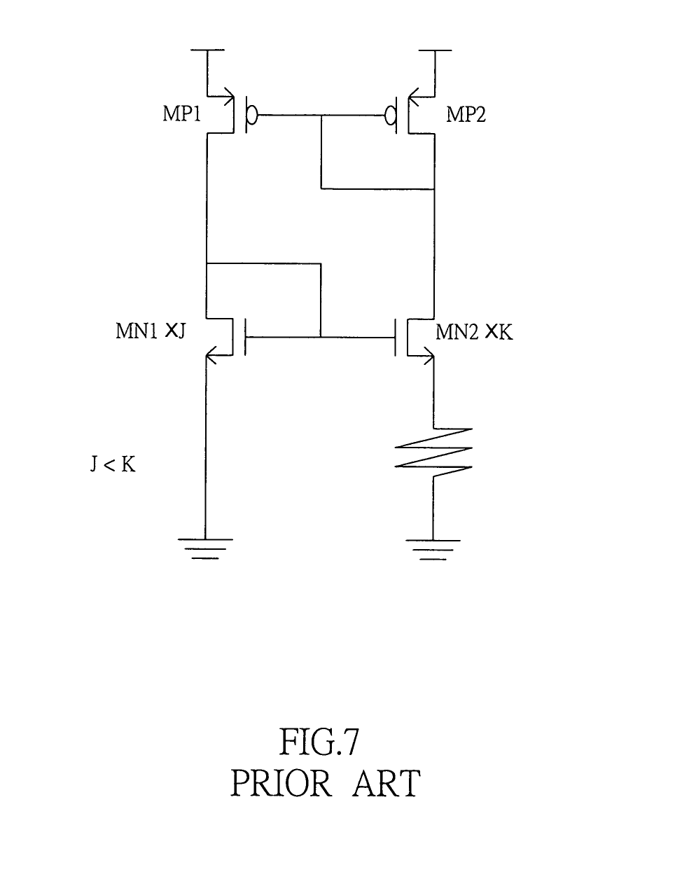

FIG. 8 is a characteristic curve graph of current versus voltage of the conventional current source circuit in accordance with the prior art; and

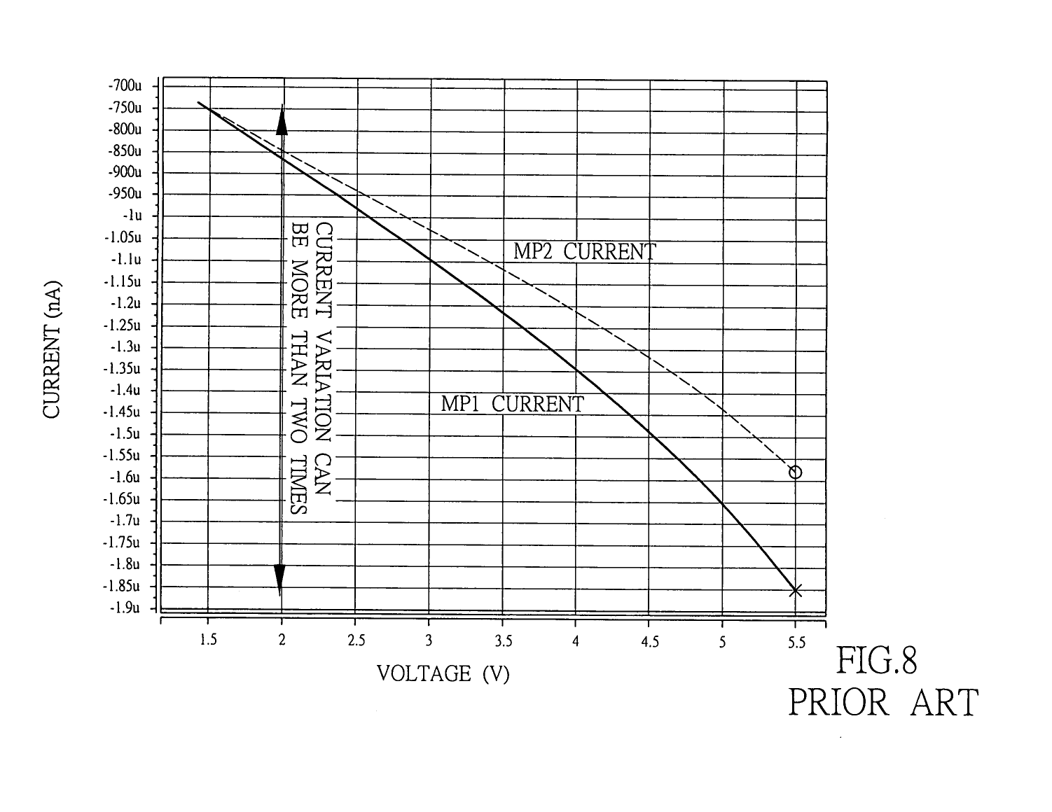

FIG. 9 is a circuit diagram of another conventional current source circuit in accordance with the prior art.

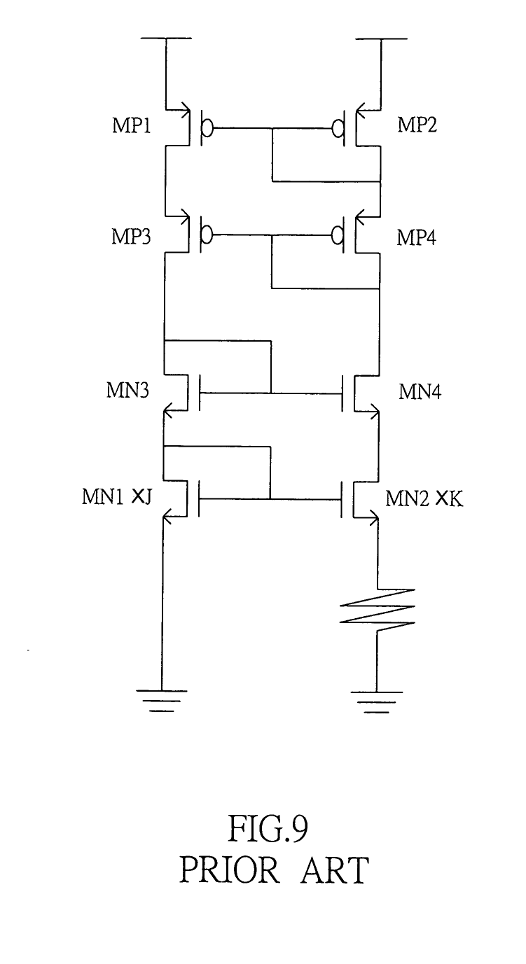

### DETAILED DESCRIPTION OF THE INVENTION

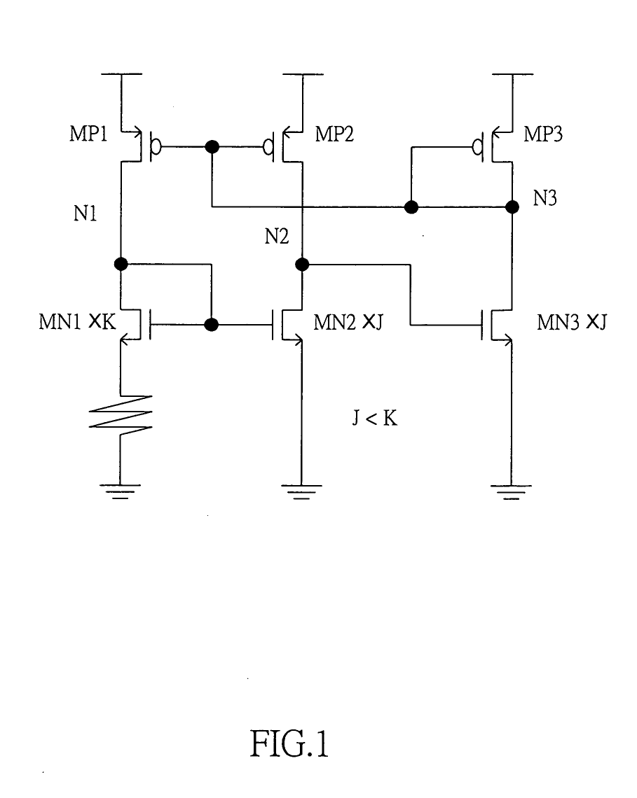

With reference to FIG. 1, a detailed circuit diagram of a preferred embodiment of the present invention of a current source circuit that is insensitive to supply voltage is shown. The current source circuit has a first current mirror, a second current mirror, a third PMOS MP1 transistor and a third NMOS transistor MN1.

The first current mirror includes a first PMOS transistor MP1 and a second PMOS transistor MP2 coupled to each other by a gate. Drains of the first PMOS transistor MP1 and the second PMOS transistor MP2 are coupled to power source VDD.

The second current mirror cascodes with the first current mirror and includes a first NMOS transistor MN1 and a second NMOS transistor MN2 coupled to each other by a gate. A connection node is further coupled to a drain of the first NMOS transistor MN1 to form a first node N1. Drains of the second PMOS transistor MP2 and the second NMOS transistor MN2 are coupled to each other to form a second node N2. Further, a source of the first transistor NMOS MN1 is coupled to a resistor R1. In terms of a difference of a circuit operation, a position of the resistor R1 is different from that of a conventional current source circuit.

The third transistor PMOS MP3 includes a gate and a drain both coupled together to the gates of the first PMOS transistor MP1 and the second PMOS transistor MP2 to form a third node N3. The third NMOS transistor MN3 includes a drain coupled to the third node N3 and a gate coupled to the second node N2.

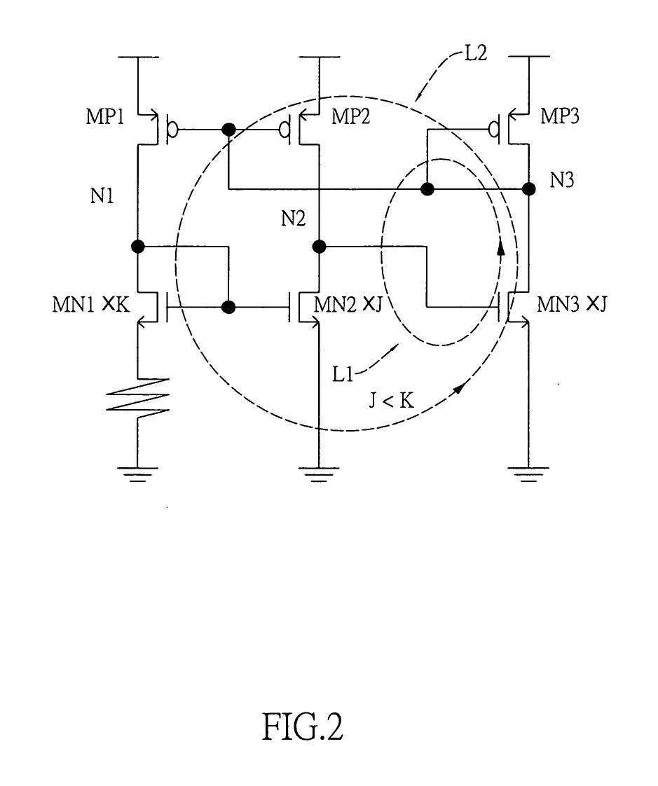

The third PMOS transistor MP3, the third NMOS transistor MN3 and the second PMOS transistor MP2 and the second NMOS transistor MN2 form a positive feedback path L1 as shown in FIG. 2. The third PMOS transistor MP3, the third NMOS transistor MN3 and the first PMOS transistor MP1 and the first NMOS transistor MN1 form a negative feedback path L2. A gain of the negative feedback path L2 is larger than a gain of the positive feedback path L1. In this way, an overall gain of the current source is effectively enhanced, so as to greatly enhance capability against the changes of the supply voltage, which achieves an objective of becoming insensitive to supply voltage.

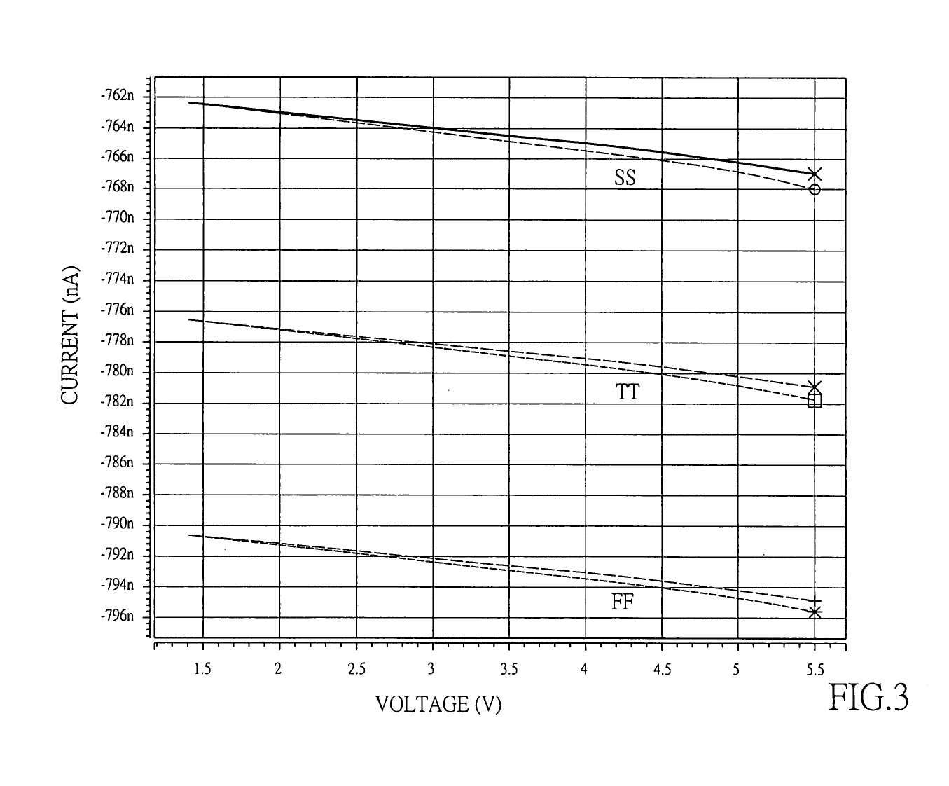

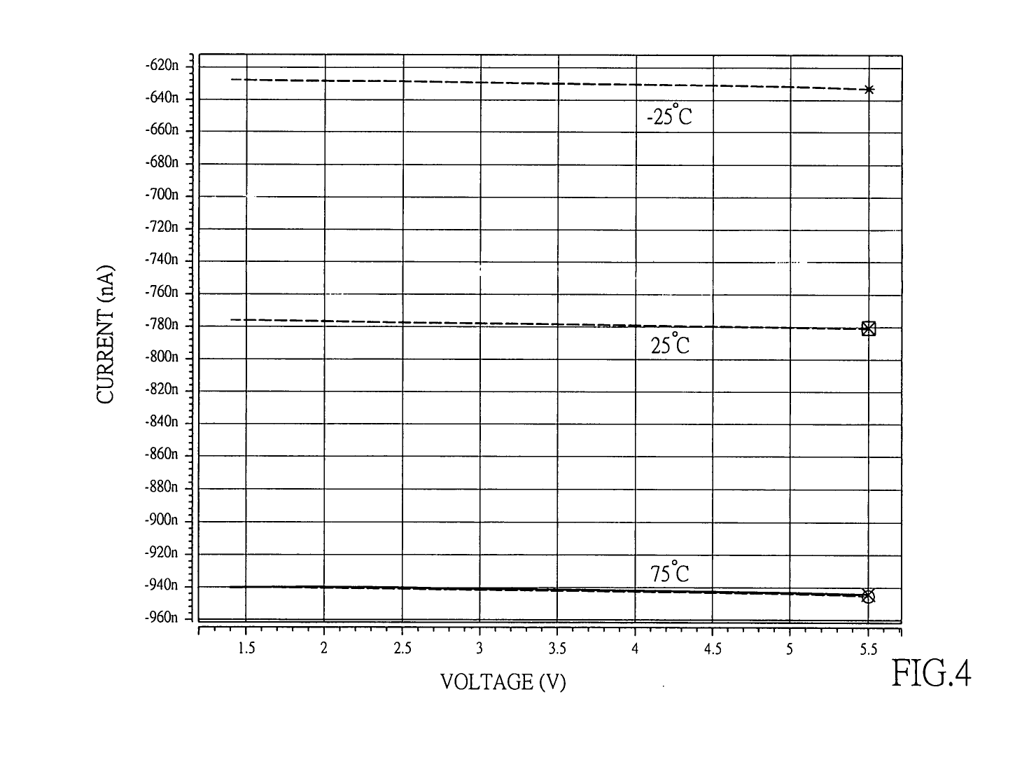

With reference to FIG. 3, a characteristic curve graph of current versus voltage shows three current values curves SS, TT and FF that are respectively generated by three current source circuits manufactured by different processes. When the supply voltage changes from 1.5 volts to 5.5 volts, the current values change for only 1% for every different process. In comparison with the conventional current source circuit that changes for more than two times (200%), sensitivity to the supply voltage of the present invention is effectively restrained. Moreover, with reference to FIG. 4, an I-V current source circuit curve diagram shows current values curves that the current source circuit operates under different temperatures of −25° C., 25° C. and 75° C. When the supply voltage changes from 1.5 volts to 5.5 volts, the current values change within only 1% under different temperatures. Therefore, the current source circuit of the present invention indeed effectively decreases the sensitivity to the changes of the supply voltage.

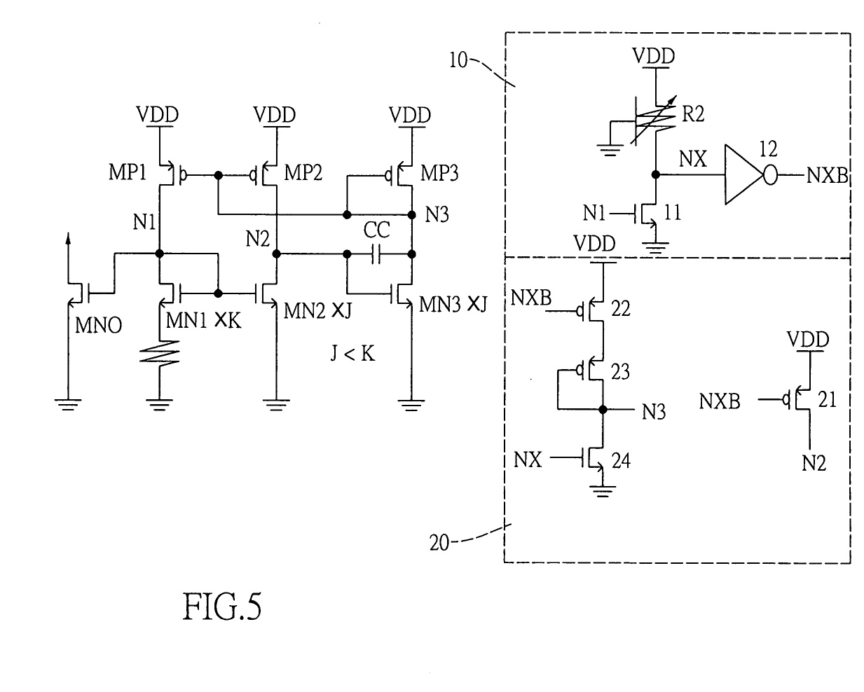

A main contribution of the current source circuit insensitive to the changes of the supply voltage of the present invention comes from the gain of the negative feedback path L2 that can reach 60 to 70 dB, which indicates PSRR (power-supply-rejection-ratio) is approximately 60 to 70 dB. Since the current source circuit in accordance with the present invention forming a dual loop of a positive feedback path and a negative feedback path can effectively enhance the overall gain of the current source, the problem when the supply voltage changes can be resolved. However, the dual loop design makes the circuit include multiple operation points. In order to make the current source circuit operates on a specific operation point; an initial circuit can be used as shown in FIG. 5. The initial circuit includes a detection circuit 10 and a driving circuit 20.

The detection circuit 10 includes a NMOS transistor 11 and an inverter 12. The NMOS transistor 11 includes a gate coupled to the first node N1 of the current source circuit and a drain coupled to power source VDD through a resistor R2. The resistor R2 is equivalent simulated by a PMOS transistor. An output terminal of the inverter 12 is coupled to the drain of the NMOS transistor 11. The output terminal of the inverter 12 forms an output terminal of the detection circuit 10.

The driving circuit 20 includes a switch transistor 21 and a cascode transistor module. The switch transistor 21 is a PMOS transistor having a gate coupled to the output terminal of the detection circuit 10 and a drain coupled to the second drain node N2 of the current source circuit.

The cascode transistor module includes two PMOS transistors 22, 23 and one NMOS transistor 24 of series connection. A gate of the PMOS transistor 22 is coupled to the output terminal of the detection circuit 10 and a source of the PMOS transistor 23 is coupled to the drain of the PMOS transistor 22. The gate and the drain of the PMOS transistor 23 are coupled to the third node N3. A drain of the NMOS transistor 24 is coupled to the drain of the PMOS transistor 23.

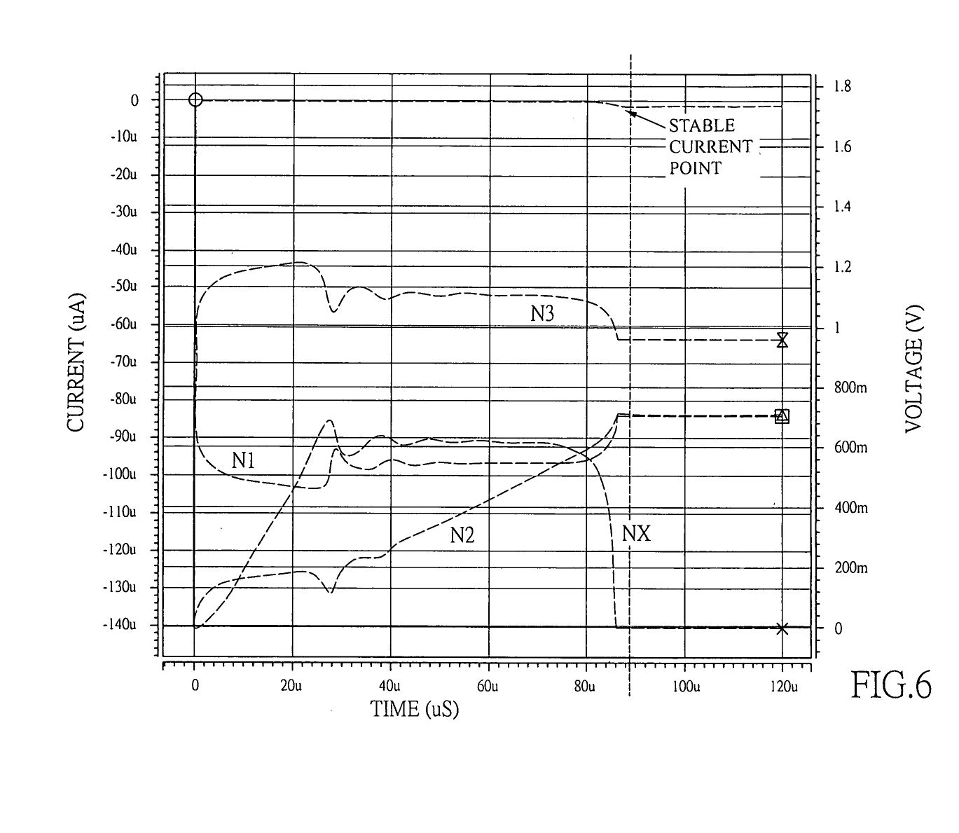

When the current source circuit in accordance with the present invention is electrically connected to the power source VDD, the input terminal of the detection circuit 10 acquires a low electric potential from the first node N1 of the current source circuit. The output terminal of the inverter 12 of the detection circuit 10 immediately outputs a low electric potential. With the switch transistor 21, the second node N2 of the current source circuit becomes high electric potential. At the same time, the PMOS transistor 22 and the NMOS transistor 24 of the cascode transistor module are conductive, so as to decrease the electric potential of the third node N3 of the current source circuit. A main objective of the PMOS transistor 23 is to control a voltage value of the third node N3. With reference to FIG. 6, an I-V curve diagram of the first node N1, the second node N2 and the third node N3 are disclosed. When the electric potential of the first node N1 and the third node N3 starts to change, the aforesaid positive feedback and the negative feedback start to work. Hence eventually the current reaches a stable position at a specific operation point as shown in the upper right corner of the diagram.

To sum up, the current source circuit of the present invention provides the particular circuit design to make the current source circuit include the positive and negative feedback paths. With the aforesaid design, the whole system can operate stably, which not only effectively enhances the overall gain of the current source but also effectively resolves the sensitivity problem when the supply voltage changes. Therefore, the current source circuit of the present invention indeed includes features of good utility and unobviousness to meet the requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A current source circuit that is insensitive to supply voltage comprising:
a first current mirror having a first PMOS transistor and a second PMOS transistor coupled to each other by a gate to form a gate connection node;
a second current mirror cascoding with the first current mirror and having a first NMOS transistor and a second NMOS transistor coupled to each other by a gate, wherein a connection node of the first and second NMOS transistors is further coupled to a drain of the first NMOS transistor, a drain of the first NMOS transistor is coupled to a drain of the first PMOS transistor to form a first drain connection node, and a drain of the second NMOS transistor is coupled to drain of the second PMOS transistor to form a second drain connection node
a third PMOS transistor comprising a gate and a drain both coupled together to the gate connection node of the first current mirror;
a third NMOS transistor comprising a drain coupled to the drain of the third PMOS transistor to form a third drain connection node and a gate coupled to the second drain connection node of the second PMOS transistor and the second NMOS transistor.

2. The current source circuit as claimed in claim 1, wherein the source of the first NMOS transistor is coupled to a resistor.

3. The current source circuit as claimed in claim 1, further comprising an initial circuit, wherein the initial circuit comprises:
a detection circuit comprising an input terminal coupled to the first connection node of the first PMOS transistor and the first NMOS transistor; and
a driving circuit comprising an input terminal coupled to the detection circuit and a plurality of output terminals respectively coupled to the first, second and third drain connection nodes.

4. The current source circuit as claimed in claim 2, further comprising an initial circuit, wherein the initial circuit comprises:
a detection circuit comprising an input terminal coupled to the first connection node of the first PMOS transistor and the first NMOS transistor; and
a driving circuit comprising an input terminal coupled to the detection circuit and a plurality of output terminals respectively coupled to the first, second and third drain connection nodes.

5. The current source circuit as claimed in claim 3, wherein the detection circuit comprises:
a NMOS transistor comprising a gate coupled to the drain node of the first PMOS transistor and the first NMOS transistor and a drain coupled to power source through a resistor; and
an inverter comprising an output terminal coupled to the drain of the NMOS transistor, wherein the output terminal forms an output terminal of the detection circuit.

6. The current source circuit that is insensitive to supply voltage as claimed in claim 4, wherein the detection circuit comprises:
a NMOS transistor comprising a gate coupled to the drain node of the first PMOS transistor and the first NMOS transistor and a drain coupled to power source through a resistor; and
an inverter comprising an output terminal coupled to the drain of the NMOS transistor, wherein the output terminal forms an output terminal of the detection circuit.

7. The current source circuit that is insensitive to supply voltage as claimed in claim 5, wherein the driving circuit comprises:
a switch transistor comprising a gate coupled to the output terminal of the detection circuit and a drain coupled to the drain node of the second PMOS transistor and the second NMOS transistor;
a cascode transistor module comprising two PMOS transistors and one NMOS transistor of series connection, wherein a gate of one of the PMOS transistors is coupled to the output terminal of the detection circuit and a source of the other PMOS transistor is coupled to the drain of the PMOS transistor, wherein the gate and the drain are coupled to the drain node of the third PMOS transistor and the second NMOS transistor, wherein a drain of the NMOS transistor is coupled to the drain of the PMOS transistor.

8. The current source circuit that is insensitive to supply voltage as claimed in claim 6, wherein the driving circuit comprises:
a switch transistor comprising a gate coupled to the output terminal of the detection circuit and a drain coupled to the drain node of the second PMOS transistor and the second NMOS transistor;
a cascode transistor module comprising two PMOS transistors and one NMOS transistor of series connection, wherein a gate of one of the PMOS transistors is coupled to the output terminal of the detection circuit and a source of the other PMOS transistor is coupled to the drain of the PMOS transistor, wherein the gate and the drain are coupled to the drain node of the third PMOS transistor and the second NMOS transistor, wherein a drain of the NMOS transistor is coupled to the drain of the PMOS transistor.
